(19) United States
(12) Patent Application Publication
(10) Pub. No.: US 2015/0278149 A1
(43) Pub. Date: Oct. 1, 2015

(54) Method for Real-Time HD Video Streaming Using Legacy Commodity Hardware Over an Unreliable Network

(71) Applicant: Panasonic Corporation of North America, Secaucus, NJ (US)

(72) Inventor: Boris Kogan, Gilroy, CA (US)

(73) Assignee: Panasonic Corporation of North America, Secaucus, NJ (US)

(21) Appl. No.: 14/224,132

(22) Filed: Mar. 25, 2014

(51) Int. Cl. G06F 13/42; G06F 13/40

(52) U.S. Cl. CPC G06F 13/4221; G06F 13/4068

(57) ABSTRACT

Data to be streamed from source device to destination device is processed through a plurality of pipeline stages, each responsible for handling a different part of the overall streaming process, including frame grabbing, optional scaling, change analysis, encoding and transmission. The pipeline congestion state in each pipeline stage is monitored and analyzed. Then based on this analysis, different throughput and quality controls are adjusted to optimize the frame rate experience and to maintain pipeline congestion below predetermined levels.

### FIELD

The present disclosure relates generally to video streaming and to presentation display streaming over networks, such as wireless networks.

### BACKGROUND

This section provides background information related to the present disclosure which is not necessarily prior art.

In a typical conference room situation, a person wishing to make a presentation will connect his or her computer or other presentation device to a display, such as a flat panel display or video projector within the conference room. Software on the computer or presentation device mirrors content seen on the presenter's computer or display device onto the display or projector so that others in the room can see it.

In the conventional situation, the computer or presentation device will be attached to the display or projector using a physical cable. The cable length is typically short, thus mirroring can be accomplished with little degradation in viewing quality. This physical connection works, in part, because the computer or presentation device is preprogrammed to provide a mirroring signal that conforms to the video display standards of the display or projector. For example, if a digital display is used, the video display standard will likely conform to the HDMI standard, which supports transfer of uncompressed video in a variety of formats, including several high definition formats. If an analog projector is used, the typical video display standard will likely conform to the VGA standard.

However, when the presenter substitutes a wireless connection for the physical cable, there is no guarantee that the sending device and the receiving device will conform to a common standard. In addition, viewing quality of a wirelessly communicated signal is very much subject to the frailties of the wireless network. This has made it difficult to “cut the cord,” hence many conference rooms still rely on a cabled connection between the computer or presentation device and the display or projector.

### SUMMARY

This section provides a general summary of the disclosure, and is not a comprehensive disclosure of its full scope or all of its features.

The present disclosure provides a method that supports video streaming, with real-time scaling and signal processing to match display requirements of the receiving device, and that can accommodate the shortcomings of legacy hardware and unreliable network conditions.

According to one aspect, the disclosed method of streaming data from a source device to a destination device defines a plurality of pipeline stages, including a first stage that acquires data from the source device and passes data to at least one intermediate stage, and then to a final stage that acquires data from the at least one intermediate stage and passes data to the destination device. The pipeline congestion state of each of these pipeline stages is monitored separately. These pipeline congestion states are analyzed, and based on the analysis, at least one throughput control is employed to maintain the pipeline congestion states of each pipeline stage below predetermined thresholds.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary conference room, illustrating an environment where a source device, such as a laptop computer, wirelessly streams a presentation to a destination device, such as a display.

FIG. 2 is a hardware diagram illustrating one exemplary implementation of a source device configured to mirror and stream content to a display device.

FIG. 3 is a flowchart diagram illustrating processing steps performed by the source device in streaming data, such as video data, to a destination device, such as a display device.

FIG. 4 is an overview depiction of the disclosed pipeline concept.

FIG. 5 is a further depiction of the disclosed pipeline stages, illustrating how the state of congestion or backlog of each is monitored and analyzed.

FIG. 6 is a flowchart diagram depicting the dynamic feedback driven control algorithm.

FIG. 7 is a flowchart diagram depicting the stage analysis functions of the control algorithm of FIG. 6.

FIG. 8 is a flowchart diagram depicting the performance recovery functions of the control algorithm of FIG. 6.

FIG. 9 is a flowchart diagram depicting one embodiment for analyzing the scaled frames.

Corresponding reference numerals indicate corresponding parts throughout the several views of the drawings.

### DETAILED DESCRIPTION

Example embodiments will now be described more fully with reference to the accompanying drawings.

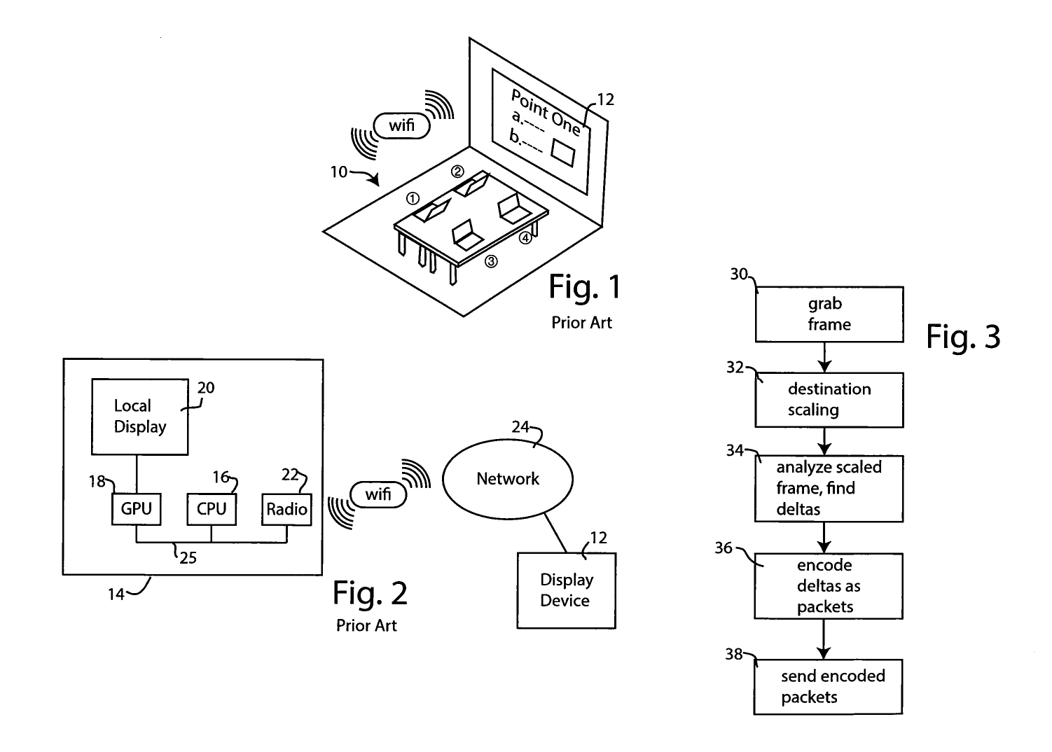

There are a number of applications where it would be desirable to provide real-time video capture and streaming, including video conferencing, desktop sharing, conference room presentations, and the like. For purposes of providing a basic overview, FIG. 1 shows an exemplary conference room 10 where a plurality of users, in this case users with laptops, each take turns giving presentations generated on the individual's laptop and projected or otherwise electronically delivered to a screen or display 12. The material being displayed may range from motion picture or video to static pages of an electronically generated slide presentation, which may include text, pictures and graphics, and video, for example.

In the early days, a user would connect his or her laptop computer to the projector or display using a hardwired cable. However, with the advent of mobile devices having wireless communication capabilities (e.g., laptop computers, smartphones, personal digital assistants, wearable communicating technology, and the like), many users prefer wireless connectivity that no longer requires the hardwired cable.

Thus, as illustrated in FIG. 1, the mobile devices (in this case laptop computers) capture content, such as slide presentation content and video content within the mobile device and transmit that content wirelessly to the display 12. While such streaming of video data is theoretically feasible, there are a number of situations where the user experience is degraded due to system latency and the overall unreliability of WiFi and other wireless networks.

Before discussing how the present disclosure addresses these problems, some understanding of the basic hardware and system architecture may be helpful. Therefore, refer to FIG. 2 where an exemplary mobile device 14 has been illustrated. The device includes a central processing unit, or CPU 16, which communicates with a graphics processing unit GPU 18 that in turn drives the local display 20 of mobile device 14. The mobile device 14 also includes a radio 22 to support wireless communication over a wireless network 24 using suitable wireless communication technologies such as WiFi, cellular communication, and the like. In this regard, although a WiFi communication system has been depicted here, other wireless systems are also envisioned. For example, while current Bluetooth standards do not support high definition video streaming, it is anticipated that someday such a technology will be developed, in which case the present disclosure may be applicable.

The procedure by which content on local display 20 is streamed to display device 12 can be better understood with reference to FIG. 3. At any given point in time, a frame of visual content is displayed on the local display by operation of the graphical processing unit (GPU) 18. It will be understood that the GPU typically has certain memory allocated for use by the GPU and such memory essentially maps onto the local display 20. When it is desired to take what is shown on the local display and transport it to the display device, the first step involves grabbing a frame of data (step 30) from the GPU memory. This entails communication between the GPU 18 and the CPU 16 whereby the frame of data would be transmitted over the local computer bus 25. The speed of the local computer bus will, of course, depend on what technology is employed.

Next, the frame of data may need to be scaled to accommodate the requirements of display device 12. Such destination scaling (step 32) is typically performed by CPU 16. It will be appreciated that the amount of time used to perform destination scaling will depend on the complexity of the scaling requirements on a case-by-case basis and also upon the inherent speed of the CPU 16.

So far the data captured from the local display (scaled if necessary) exists in a frame-based format, generally corresponding to the format needed to display the information on a display device. (We refer to display data in this format as being in the frame-domain.)

Transmitting data wirelessly is a resource-intensive task. Thus, it is typical to apply an encoding algorithm to reduce the quantity of data before it is communicated over the wireless network. In many instances, such encoding involves comparing the frame of data to a previous frame of data, computing what portions of the frame have changed (or not changed) and generating an encoded representation of the frame where only the changes or “deltas” are expressed in the data. The analysis to perform this compression is performed by CPU 16 (at step 34).

In order to transmit the frame of data over a radio network, such as a WiFi network, certain repackaging of the data is typically required. In this regard, most wireless networks today are packet-based networks where the data are sent as packets corresponding to a predefined protocol (e.g., TCP, UDP, etc.). Thus the frame-domain data will typically need to be converted into the packet-domain in order to be compliant with the particular network protocols. Thus at step 36 the data are encoded as packets in the packet-domain. Such encoding is performed by CPU 16.

After the encoded deltas are formulated as packets (step 36) they are then handed off to the radio circuit 22 for transmission according to the defined wireless protocol over the wireless network 24.

In the typical wireless network, packets of data encoded in this fashion are sent from the transmitter of the sending device (radio 22 of mobile device 14) and received by the (radio) receiver associated with the receiving device, in this case display device 12. According to typical packet-based protocols, the receiver of a packet sends an acknowledgment signal back via the network to the transmitter when the packet is received. If no acknowledgment is received, the transmitter assumes the packet has been lost and thus retransmits the packet, continuing to do so in this fashion until the packet is acknowledged as received. In congested networks or networks with poor signal quality, packet delivery can become substantially degraded, resulting in slower data transfer rates.

In a conventional wireless data transmission system, the overall latency or speed at which data are transferred from sending device to receiving device is essentially the cumulative delay produced by each of the steps 30-38 (FIG. 3). Thus the conventional wisdom is to utilize devices with the fastest GPU and CPU technology possible; and utilize the most robust and highest bit rate network technology available. In this way, the streaming of high definition video content stands the best chance of reaching its destination with low latency and high quality.

However, such high quality GPU and CPU components and high-speed network systems may not always be feasible. Indeed, in many typical office applications, some users may have mobile device technology that is several years out of date and the same is often true for the wireless networks. Thus the present disclosure addresses this reality by subdividing the processes depicted in FIG. 3 into individual pipeline stages that are each monitored and controlled to allocate computational resources in a dynamic fashion that maximizes the user's experience.

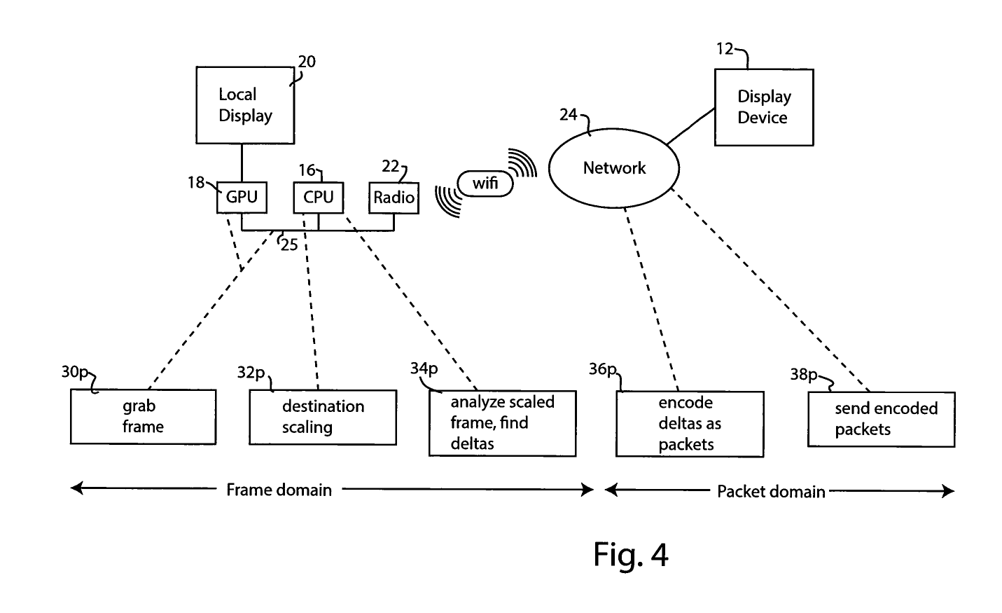

Referring to FIG. 4, the basic steps 30-38 are reengineered as individual pipeline stages 30p-38p, which are each treated by the disclosed system as parallel processes or threads. As shown in FIG. 4, each of these pipeline stages may experience a loss of throughput or bottleneck condition. However, rather than attribute the cumulative delay to each of these pipeline processes collectively (as is conventionally done as illustrated in FIG. 3), the present architecture utilizes knowledge of which components within the transmission-reception system are primarily responsible for any bottleneck associated with that process.

Thus in FIG. 4 the grab frame pipeline 30p is primarily affected by the performance of the GPU 18 and the local computer bus 25. The destination scaling pipeline 32p will exhibit bottlenecks attributable primarily to the performance of CPU 16. The same is true for the data compression pipeline 34p. It will be seen that pipeline stages 30p, 32p, and 34p are all throughput limited by processes within the frame domain.

In contrast, the encoding pipeline 36p and the sending of encoded packets pipeline 38p will be primarily limited by the performance of network 24 and also by the performance of the display device 12. Thus pipeline stages 36p and 38p respond to conditions within the packet domain.

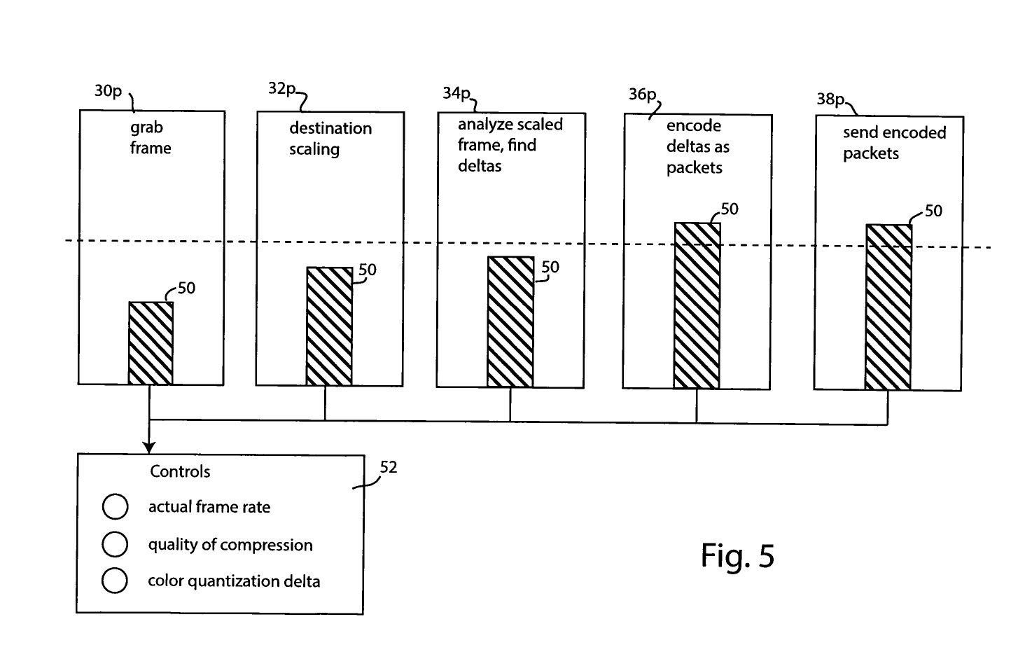

As diagrammatically illustrated in FIG. 5, the optimization technique of the disclosed system treats the pipeline stages 30p-38p as separate parallel processes or stages, each having its own instantaneous utilization statistics. These parallel processes may be run as individual threads if the processor supports multithreaded operation. Thus as depicted in FIG. 5, each pipeline stage has as a utilization counter 50 defined in memory and storing a numerical value indicative of the processing backlog associated with that pipeline stage. In FIG. 5, for example, the utilization counter 50 shows pipeline stages 36p and 38p as having a higher backlog than the other stages, with pipeline stage 30p having the lowest backlog. Essentially, the utilization counter 50 maintains the instantaneous state of each pipeline, by counting the number of processing jobs that are pending in the queue of each pipeline. The values stored in the respective utilization counters comprise pipeline statistics that the processor of the system analyzes, as will be more fully explained below.

The disclosed system uses the values stored in the utilization counters 50 to assert control over the processes associated with each of the stages to provide an optimal user experience. In the presently preferred embodiment, the controls are shown at 52 to include control over actual frame rate, control over quality of compression, and control over the color quantization delta. While these controls are presently preferred, other controls are also possible.

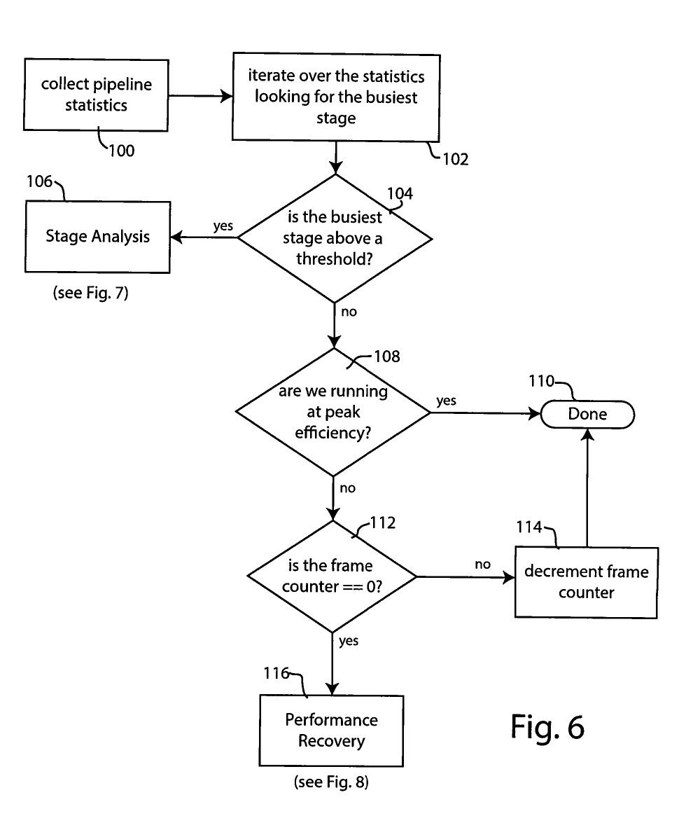

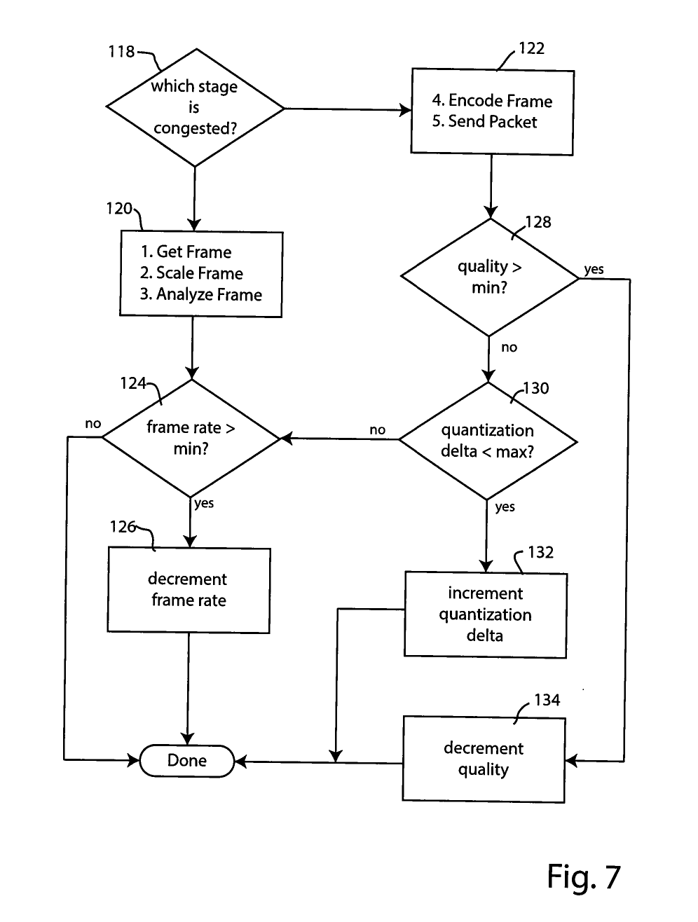

Referring now to FIG. 6, the algorithm for optimizing the pipeline stages will now be discussed. Further details are shown in the source code example which has been provided in the Appendix. These algorithmic steps are performed by the processor in the source device. First, the processor collects pipeline statistics (step 100) from each of the pipeline stages 30p-38p. The processor then iterates over the collected statistics (step 102) looking for the busiest stage. If the busiest stage is above a predetermined threshold (step 104), the processor then performs stage analysis of that stage (step 106). The stage analysis procedure is more fully described in connection with FIG. 7, which is discussed below.

If the busiest stage is not above the predetermined threshold, then the processor assesses (step 108) if the system is running at peak efficiency. This assessment is conducted by performing the algorithm below.

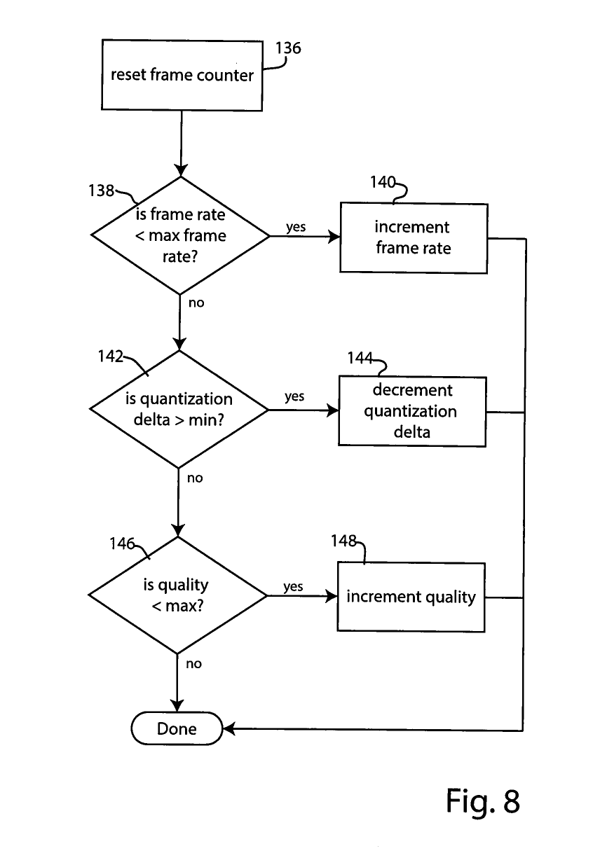

If running at peak efficiency, then the dynamic feedback-driven control process terminates at step 110. On the other hand, if not running at peak efficiency, the frame counter is decremented (steps 112 and 114) and the procedure terminates (step 110). Such frame counter decrementing continues until the frame counter reaches 0 at which point the performance recovery procedure (step 116) is performed. The performance recovery procedure is illustrated in detail in FIG. 8, discussed below.

Referring now to FIG. 7, the stage analysis procedure begins by first analyzing which stage is congested. In this regard, it will be recalled that the dynamic feedback-driven control procedure of FIG. 6 singles out the busiest stage above a predetermined threshold, thus the busiest stage is the one that is analyzed in the stage analysis procedure of FIG. 7. If the stage being analyzed corresponds to pipeline stages 30p, 32p, or 34p the stage analysis procedure branches to step 120. On the other hand, if the congested stage corresponds to pipeline stages 36p or 38p then the procedure branches to step 122. It will be appreciated that the branch corresponding to step 120 corresponds to operations in the frame-domain (as shown in FIG. 4); whereas operations corresponding to the branch of step 122 correspond to processes operating in the packet-domain.

Taking the branch of step 120 first, the procedure first examines the frame rate (step 124) to determine if it is still greater than a minimum frame rate. If so, then the frame rate is decremented (step 126). As illustrated, if the frame rate is already at the minimum, then no further decrementing is performed.

Following the branch associated with step 122, the procedure first tests (at step 128) whether the image quality is currently greater than a predefined minimum quality. If so, then the procedure decrements the image quality (step 134). Alternatively, if the image quality is already at a minimum, then a further test is performed (at step 130) to determine whether the quantization delta is less than a predetermined maximum. If so, then the procedure (at step 132) increments the quantization delta. If not, the procedure branches to step 124 where the frame rate will be further decremented unless it has already been decremented to the minimum value.

Referring now to FIG. 8, the performance recovery procedure will be described. It will be recalled that the performance recovery procedure is performed (as shown in FIG. 6) once the frame counter has been decremented to 0. The performance recovery procedure begins (at step 136) by resetting the frame counter. If the frame rate is less than a predetermined maximum frame rate (at step 138), then the frame rate is incremented (at step 140). Alternatively, if the frame rate is not less than the maximum frame rate, the procedure then branches (to step 142) to ascertain whether the quantization delta is greater than a minimum predetermined value. If so, then the quantization delta is decremented (at step 144). If not, the procedure then branches (to step 146) which tests whether the image quality is less than a maximum quality. If so, the image quality is incremented (at step 148). If not, the performance recovery routine terminates.

By way of summarizing FIGS. 6, 7, and 8, the algorithm uses the pipeline load statistics to dynamically adjust the effective frame rate and/or effective quality to match the resource constraints. Note that the dynamic adjustment is made entirely based on local data (pipeline statistics) to make the dynamic adjustments. The procedure does not directly rely on information extracted externally from the network path (e.g., ping, ICMP). In the illustrated algorithm, the frame counter (tested and decremented at steps 112 and 114) serves to dampen the oscillatory nature of the adjustment mechanism. Without it, the adjustments would swing back and forth, possibly negating the tuning performed during analysis and potentially creating jarring visual effects. The algorithm is tuned so that once the respective pipeline stages are under control, the effective frame rate and effective quality can be increased until peak efficiency is achieved.

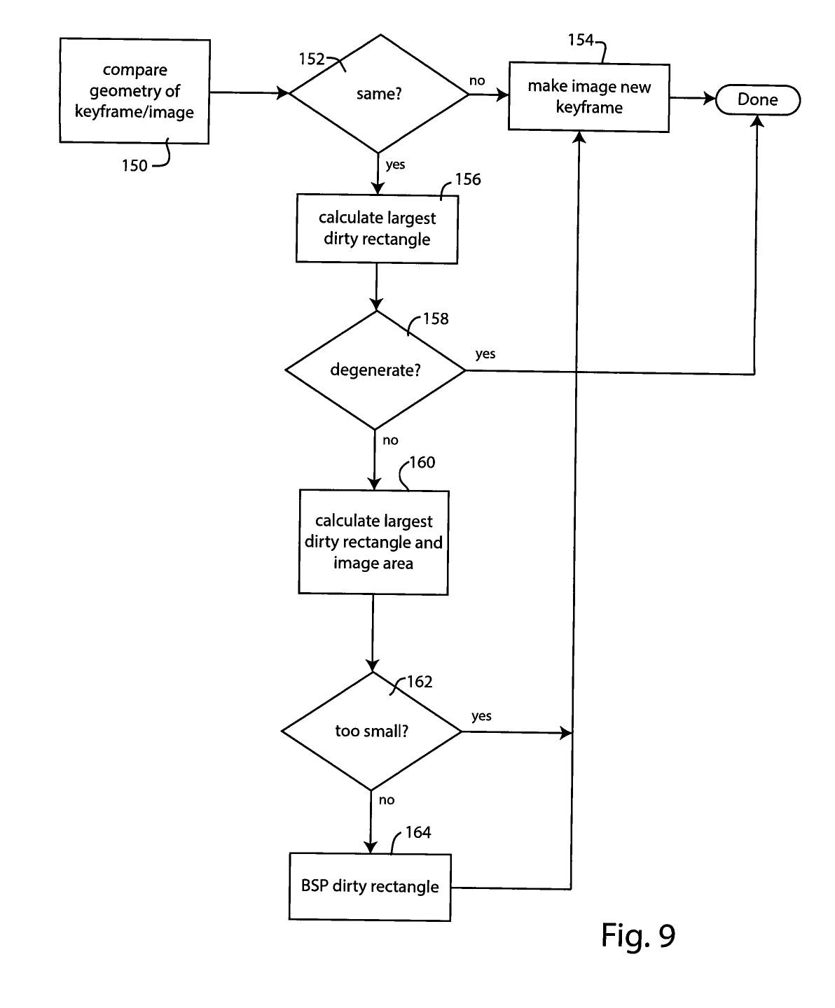

FIG. 9 shows one embodiment of an algorithm performed by the CPU 16 to perform the analysis for the pipeline stage 34p. Generally, the analysis is designed to identify where changes in the image have occurred between one frame and another. The illustrated analysis uses a BSP (binary space partitioning) algorithm, but other alternative algorithms are possible. The algorithm begins (step 150) by comparing the geometry of the keyframe with that of the image. If these are the same, a calculation is performed (step 156) which calculates the largest dirty rectangle. Such calculation involves dividing the screen into segments and identifying those segments where change has occurred between the keyframe and the image. On the other hand, if the keyframe and the image are not the same, the image is stored in memory to become the new keyframe (step 154) for the next pass through the analysis phase algorithm. After calculating the largest dirty rectangle, a test is performed (at step 158) do determine if degeneration has occurred. If so, the process ends. Otherwise, a further calculation of a dirty rectangle is performed (step 160).

Because the BSP algorithm is recursive, it can sometimes produce many small regions (as it partitions the space). When the regions become too small this may cause difficulty for the JPEG encoder. Thus a test is performed (step 162) to determine if the partitioned regions have become too small for the encoder. If so, the image is saved as the new keyframe (step 154). Otherwise, another BSP dirty rectangle is calculated (step 164).

In the exemplary use case illustrated in FIG. 1, the user of a wireless device is giving a slide show presentation on the display. The disclosed technology described here may be used with considerable benefit, because the pipeline monitoring and throughput adjusting techniques allow the audience to perceive an optimal, high quality presentation, even when some of the components in the system (such as components within the source device, and the wireless network) are less than optimal. Here the disclosed techniques can be further tuned to give even better user experience, by analyzing the data being streamed to determine whether it represents moving picture video, static slides, or a combination of the two.

To accomplish this, the algorithm may be modified or augmented to monitor the frame-to-frame change, applying floor and ceiling thresholds to determine whether the current frame represents either motion picture video or a static presentation slide. The frame-to-frame change is assessed by monitoring the deltas from frame to frame. If the frame-to-frame deltas are low (very little change from frame to frame) the algorithm concludes that the image being streamed corresponds to a static presentation slide. On the other hand, if the frame-to-frame deltas are high, the algorithm concludes that the image being streamed is a motion picture video.

Making the determination of static slide vs. video is quite important when one considers the psycho-visual qualities of human vision. When a human views a static presentation slide, it is the sharpness and crispness of the text that is most important. However, when a human views a motion picture video, it is the frame-to-frame smoothness (absence of jerkiness) that is most important. When viewing a video, the human is able to ignore a softness in the images (lack of sharpness); but jerky frame-to-frame transitions are immediately recognized as poor quality.

By detecting whether the streamed content is static page vs. video, the present system optimizes the user experience as follows. If the system detects that the images correspond to presentation slides, then frame rate can be reduced, even significantly, without substantially degrading the user experience. This is so because in the typical slide presentation, the presenter may change slides on an average of once every 5 to 30 seconds. Clearly, a frame rate of 30 frames per second is not required to handle this. However, when the system detects that the images correspond to presentation slides, compression quality adjustments are applied more conservatively, as adjustment of these controls will affect crispness of the text.

On the other hand, if the system detects that the images correspond to a motion picture video, then frame rate adjustments are applied more conservatively, and compression quality adjustments are applied more liberally. This is so because as long as the frame rate remains adequately fast to avoid jerkiness, the viewer will be satisfied with the presentation, even if the details within each frame are soft or slightly blurred due to high data compression.

The system makes these adjustments (static slide vs. motion picture video) by employing different thresholds, depending on which type of content is being conveyed.

There is a third use case, where the presenter employs predominately static slides which have embedded in them a motion picture video. Usually the video is presented in a window that is smaller than the overall size of the slide, so that text is also viewable while the video is being run. The system detects this use case by subdividing the overall frame into regions and separately assessing the change in deltas for each region individually. When an embedded video is found within a slide, the algorithm treats the slide as if it contains only a static slide presentation page, effectively suppressing the influence of the dynamic video component of the frame and thus allowing frame rate reductions to be performed, as needed. This can be accomplished, for example, by suppressing the data obtained from that region, thus allowing the remaining regions (of static content) to dominate the statistical analysis.

From the foregoing it will be understood that the disclosed method of streaming data operates to optimize the viewing experience by analyzing pipeline statistics gathered internally by the processor within the source device that is effecting the streaming. The method does not require information from the destination device, nor does the method require a priori knowledge about network conditions. In other words, the processor performing the data manipulations needed to stream to the destination device is collecting and analyzing its own statistical data regarding its own internal pipeline congestion states. Using this internally-generated statistical information, the processor is able to tune the data processing parameters (e.g., frame rate, quality of compression, and color quantization delta) to optimize the viewing experience even where the hardware and network capabilities are less than optimal.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of streaming data from a source device to a destination device, comprising:
defining a plurality of pipeline stages, including a first stage that acquires data from the source device and passes data to at least one intermediate stage, and a final stage that acquires data from the at least one intermediate stage and passes data to the destination device;
monitoring, separately for each pipeline stage, a pipeline congestion state for each of said pipeline stages; and
analyzing the pipeline congestion states of each pipeline stage and based on the analysis applying at least one throughput control to maintain the pipeline congestion states of each pipeline stage below predetermined thresholds.

2. The method of claim 1 further comprising defining the following pipeline stages:
a. a data acquisition stage that acquires frame-based data from the source device;
b. a destination scaling stage that receives acquired data from the data acquisition stage and optionally applies a predetermined scaling process on the acquired data;
c. a data analysis stage that receives data from the destination scaling stage and applies a predefined analysis algorithm on the data received from the destination scaling stage;
d. an encoding stage that receives and converts data from the data analysis stage into data packets; and
e. a data transmission stage that receives and sends data packets received from the encoding stage to the destination device.

3. The method of claim 1 wherein the data acquired from the source device is frame-based data and wherein the throughput control adjusts a frame rate parameter associated with the frame-based data.

4. The method of claim 1 wherein said at least one intermediate stage performs data compression and wherein the throughput control adjusts a quality parameter associated with the data compression performed by said at least one intermediate stage.

5. The method of claim 1 wherein the data acquired from the source device is frame-based data and wherein said final stage passes data to the destination device as packets that encode information extracted from the frame-based data.

6. The method of claim 1 wherein the at least one intermediate stage performs color quantization and wherein the throughput control adjusts a parameter controlling the degree to which color quantization is performed.

7. The method of claim 1 wherein the at least one intermediate stage performs data compression using a recursive binary space partitioning algorithm.

8. The method of claim 1 wherein the data acquired from the source device is frame-based data and wherein the method further comprises monitoring the degree of frame-to-frame changes to discern whether the frame-based data corresponds to moving content or static content.

9. The method of claim 8 further comprising applying the at least one throughput control differently, depending on whether the frame-based data corresponds to moving content or static content.

10. The method of claim 1 wherein the data acquired from the source device is frame-based data and wherein the method further comprises partitioning a frame into regions and then within each region monitoring the degree of frame-to-frame changes to discern whether one or more of the regions corresponds to moving content.

11. The method of claim 10 further comprising, when a region is discerned to contain moving content, suppressing that region from being used in performing the step of analyzing the pipeline congestion states.

12. An apparatus for streaming data from a source device to a destination device, comprising:
a processor in the source device which is programmed to define a plurality of pipeline stages, including a first stage that acquires data from the source device and passes data to at least one intermediate stage, and a final stage that acquires data from the at least one intermediate stage and passes data to the destination device;
the processor being further programmed to monitor separately for each pipeline stage, a pipeline congestion state for each of said pipeline stages; and
the processor being further programmed to analyze the pipeline congestion states of each pipeline stage and based on the analysis to apply at least one throughput control to maintain the pipeline congestion states of each pipeline stage below predetermined thresholds.

13. The apparatus of claim 12 wherein the processor is programmed to define the following pipeline stages:
a. a data acquisition stage that acquires frame-based data from the source device;
b. a destination scaling stage that receives acquired data from the data acquisition stage and optionally applies a predetermined scaling process on the acquired data;
c. a data analysis stage that receives data from the destination scaling stage and applies a predefined analysis algorithm on the data received from the destination scaling stage;
d. an encoding stage that receives and converts data from the data analysis stage into data packets; and
e. a data transmission stage that receives and sends data packets received from the encoding stage to the destination device.

14. The apparatus of claim 12 wherein the data acquired from the source device is frame-based data and wherein the processor adjusts a frame rate parameter associated with the frame-based data to apply the at least one throughput control.

15. The apparatus of claim 12 wherein the processor in implementing said at least one intermediate stage performs data compression and wherein the throughput control adjusts a quality parameter associated with the data compression performed by said at least one intermediate stage.

16. The apparatus of claim 12 wherein the data acquired from the source device is frame-based data and wherein the processor in implementing said final stage passes data to the destination device as packets that encode information extracted from the frame-based data.

17. The apparatus of claim 12 wherein the processor in implementing the at least one intermediate stage performs color quantization and wherein the throughput control adjusts a parameter controlling the degree to which color quantization is performed.

18. The apparatus of claim 12 wherein the processor in implementing the at least one intermediate stage performs data compression using a recursive binary space partitioning algorithm.

19. The apparatus of claim 12 wherein the data acquired from the source device is frame-based data and wherein the processor is further programmed to monitor the degree of frame-to-frame changes to discern whether the frame-based data corresponds to moving content or static content.

20. The apparatus of claim 19 wherein the processor applies the at least one throughput control differently, depending on whether the frame-based data corresponds to moving content or static content.

21. The apparatus of claim 12 wherein the data acquired from the source device is frame-based data and wherein the processor is further programmed to partition a frame into regions and then within each region monitor the degree of frame-to-frame changes to discern whether one or more of the regions corresponds to moving content.

22. The apparatus of claim 21 further comprising, when a region is discerned to contain moving content, the processor suppressing that region from being used in analyzing the pipeline congestion states.
